(19) United States
(12) Patent Application Publication
(10) Pub. No.: US 2003/0169909 A1
(43) Pub. Date: Sep. 11, 2003

(54) Work time management method and work time management apparatus

(76) Inventor: Junichi Yamagishi, Taito-ku (JP)

Correspondence Address: JORDAN AND HAMBURG LLP, 122 EAST 42ND STREET, SUITE 4000, NEW YORK, NY, 10168, US

(21) Appl. No.: 10/095,402

(22) Filed: Mar. 11, 2002

(51) Int. Cl. H04K 1/00; G06K 9/00

(52) U.S. Cl. 382/124; 713/186

(57) ABSTRACT

A method and an apparatus for enabling to facilitate a management of a work time.

A work time management apparatus comprises activation restricting means CL1 for, when a worker activates a work object O, restricting an activation thereof, fingerprint inputting means CL2 for inputting a fingerprint of the worker, fingerprint registering means CL3 for registering a fingerprint of each worker in advance, fingerprint collating means CL4 for collating the input fingerprint with the registered fingerprint of the worker, restriction releasing means CL5 for releasing the restriction according to the activation restricting means CL1 when a registered worker is specified through the fingerprint collation, and work time recording means CL6 for counting to record a work time up to the time when an operation of the work object O is terminated on the basis of the fact that the restriction has been released.

### BACKGROUND OF THE INVENTION

1. Field of the Invention

The present invention relates to a work time management method and a work time management apparatus for managing the operation time of an information device or the like through fingerprint collation.

2. Description of the Related Art

Conventionally, a recording of the work or operation time of workers or employees in a workplace or an office is conducted by punching their arrival and departure times in a time recorder.

However, in a case that the recording is made by the time recorder, it is impossible to confirm a place where each employee operates a machine or each worker works and his/her operation or work contents in the office or workplace so that an improvement thereof is desirable.

It is an object of the present invention to provide a work time management method and a work time management apparatus capable of securely managing each worker who works or each employee who operates a machine, a place where he/she works or operates a machine and his/her work or operation contents by recording a work or operation time through a fingerprint collation.

### SUMMARY OF THE INVENTION

A first aspect of the present invention provides a work time management method comprising the steps of: when a worker activates a work object, restricting an activation of the work object; when the worker inputs his/her fingerprint, collating the input fingerprint with a fingerprint of the worker which has been registered in advance, and releasing an activation restricting of the work object when a registered worker is specified through the fingerprint collation; and counting a work time up to the time when the operation of the work object is terminated to record the work time of the specified worker on the basis of the fact that the activation restricting is released.

A second aspect of the present invention provides a work time management apparatus comprising: activation restricting means for, when a worker activates a work object, restricting an activation of the work object; fingerprint inputting means for inputting a fingerprint of the worker; fingerprint registering means for registering a fingerprint of each worker in advance; fingerprint collating means for collating the input fingerprint with the registered fingerprint of the worker; restriction releasing means for, when a registered worker is specified through the fingerprint collation, releasing the restriction according to the activation restricting means; and work time recording means for counting to record the work time up to the time when the operation of the work object is terminated on the basis of the fact that the restriction is released.

A third aspect of the present invention provides the work time management apparatus according to the second or third aspect, further comprising: work confirming means for making a determination on whether an operation of the work object is being conducted or not; and terminating means for forcibly terminating the work object when it is determined that the operation of the work object is not being conducted, wherein the work time recording means counts to record a work time up to the forcible termination.

A fourth aspect of the present invention provides the work time management apparatus according to the second or third aspect, wherein the work object is any one of a work program of an information device, a vehicle, and a heavy-duty machine.

According to the first aspect, when a worker activates a work object, when the worker conducts noting, an activation of the work object is restricted. When the worker inputs his/her fingerprint, the input fingerprint is collated with the fingerprint which has been registered in advance. When a registered worker is specified through the fingerprint collation, the activation restricting of the work object is released. A work time up to the time when an operation of the work object is terminated is counted on the basis of the fact that the activation restricting has been conducted so that the work time of the specified worker can be recorded. Therefore, it is possible to confirm each worker who works, a place where he/she works and his/her work time, so that it is possible to accurately make a work time management.

According to the second aspect, when the worker activates the work object, the activation can be restricted according to the activation restricting means. With the fingerprint inputting means, a fingerprint of the worker can be input. With the fingerprint registering means, a fingerprint of each worker can be registered in advance. With the fingerprint collating means, the input fingerprint can be collated with the registered fingerprint of the worker. When the registered worker is specified through the fingerprint collation, the restriction according to the activation restricting means is released according to the restriction releasing means so that the work time up to the time when the operation of the work object terminated can be counted to be recorded on the basis of the fact that the restriction has been released. Therefore, it is possible to confirm a worker who works or operates a machine, his/her working or operating place, the contents of his/her work object and his/her work time thereto, and it is possible to accurately manage the work time.

According to the third aspect, in addition to the effect of the second aspect, a determination can be made on whether the work object is being operated through the work confirming means. With this determination, when it is determined that the work object is not being operated, the work object is forcibly terminated through the terminating means. The work time recording means can count to record the work time up to the time when the work object is forcibly terminated. Therefore, for example, when, once the work object is operated, however, the worker changes to another work so that the operation of the work object is stopped halfway, the work time up to that time is counted so that a management of the work time can be more accurately conducted.

According to the fourth aspect, in addition of the effect of the second or third aspect, the work object is any one of a work program of an information device, a vehicle, and a heavy-duty machine so that it is possible to appropriately manage an operating time on a work program executed by an operator, or a driving or operating time where a driver drives the vehicle or an operator operates the heavy-duty machine.

### BRIEF DESCRIPTION OF THE DRAWINGS

FIG. 1 is a block diagram according to the present invention;

FIG. 2 is a perspective view of a desktop personal computer to which one embodiment according to the present invention is applied;

FIG. 3 is a block diagram of a fingerprint collation according to the embodiment;

FIG. 4 is a flowchart in the case where a work object is a work program of an information device according to the embodiment;

FIG. 5 is a flowchart in the case where the work object is the work program of the information device according to the embodiment;

FIG. 6 is a flowchart in the case where the work object is a vehicle according to the embodiment;

FIG. 7 is a flowchart in the case where the work object is the vehicle according to the embodiment;

FIG. 8 is a flowchart in the case where the work object is heavy-duty machine according to the embodiment;

FIG. 9 is a flowchart in the case where the work object is the heavy-duty machine according to the embodiment.

### DETAILED DESCRIPTION OF THE PREFERRED EMBODIMENT

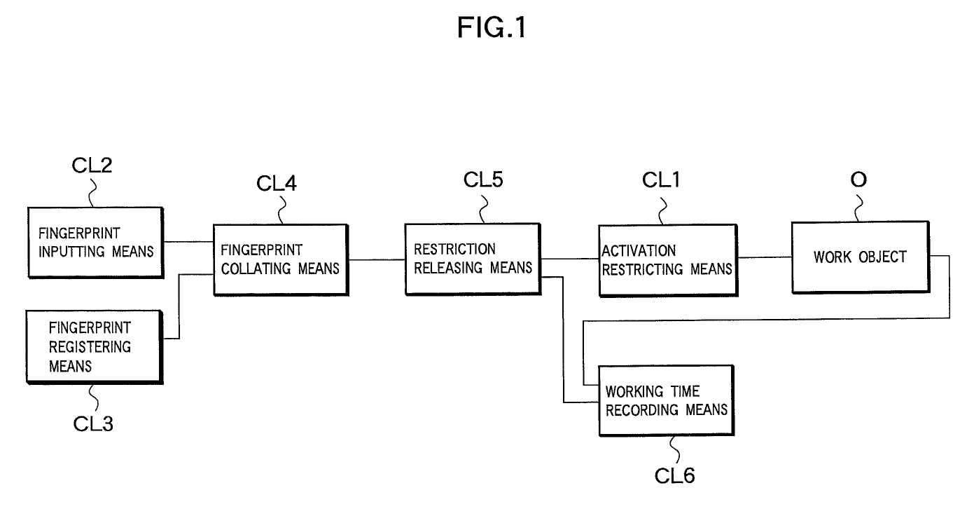

FIG. 1 is a block diagram of a work time management apparatus according to the present invention. As shown in FIG. 1, the work time management apparatus according to the present invention comprises activation restricting means CL1, fingerprint inputting means CL2, fingerprint registering means CL3, fingerprint collating means CL4, restriction releasing means CL5, and work time recording means CL6.

The activation restricting means CL1 is for, when a worker or employee activates a work object or a machine to be operated, restricting activation thereof. The fingerprint inputting means CL2 is directed for inputting a fingerprint of the worker. The fingerprint registering means CL3 is directed for registering a fingerprint of each worker in advance. The fingerprint collating means CL4 is directed for collating the input fingerprint with the registered fingerprint of the worker. The restriction releasing means CL5 is directed for releasing the restriction of the work object O according to the activation restricting means CL1 when the registered worker is specified according to the fingerprint collation. The work time recording means CL6 is directed for counting to record a work time up to the time when an operation of the work object O is terminated on the basis of the fact that the restriction of the work object O has been released. Therefore, it is possible to accurately manage a work object O which each worker operates, the contents of the work object O and a work time for the work object O.

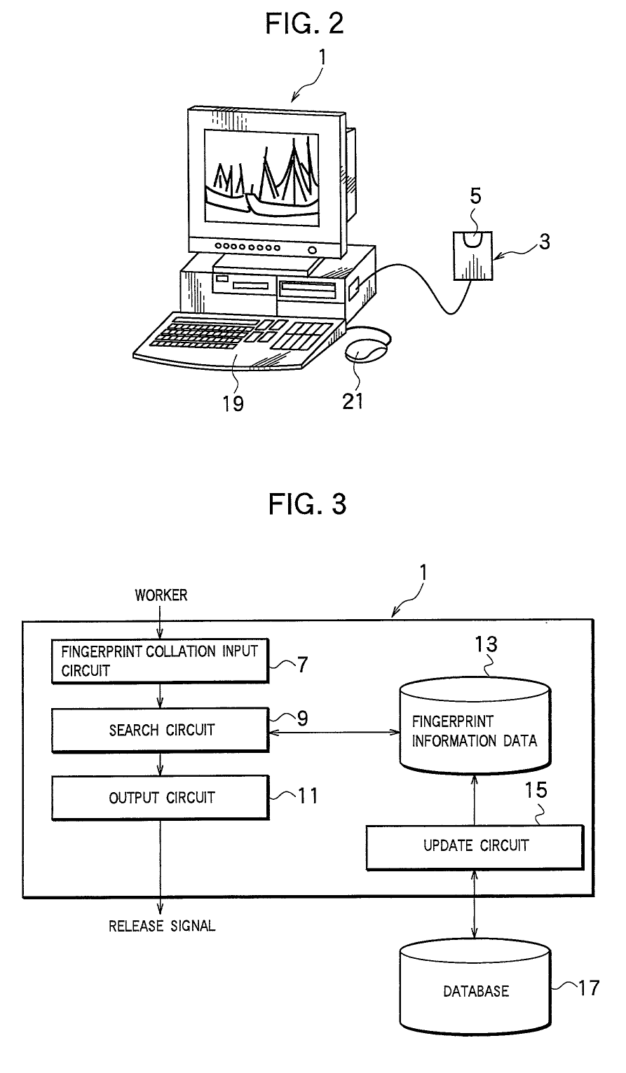

FIG. 2 is a perspective view of an information device to which an embodiment according to the present invention is applied. The information device is a desktop model personal computer (desktop PC), to which a fingerprint input device 3 is connected. The desktop PC has a plurality of kinds of work programs recorded in a memory thereof. The work program is the work object O in the present embodiment. Further, a process restricting program is input to the desktop PC 1, which configures the activation restricting means CL1. Further, the desktop PC 1 configures the fingerprint registering means CL3, the fingerprint collating means CL4, the restriction releasing means CL5, and the work time recording means CL6.

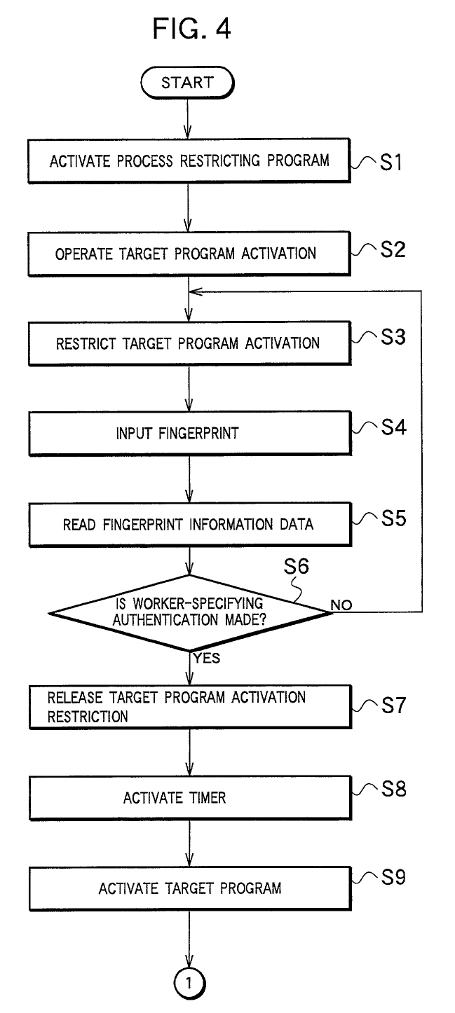

Therefore, when the worker tries to operate a target work program according to the desktop PC 1, unless the fingerprint collation is conducted, the activation of the program is restricted. When the worker touches on a fingerprint input section 5 of the fingerprint input device 3 with a specified finger to input his/her fingerprint, the target work program is started according to the fingerprint collation so that the worker can operate the work program and the work time is counted to be recorded. The details of this operation will be explained in the flowcharts of FIG. 4 and the subsequent drawings.

FIG. 3 is a block diagram of the fingerprint collation. In other words, a control section of the desktop PC 1 comprises a fingerprint collation input circuit 7, a search circuit 9, an output circuit 11, fingerprint information data 13, and an update circuit 15.

In the fingerprint information data 13, for example, respective fingerprint information data of the employees in a specific division in a workplace company is recorded. The fingerprint information data 13 is configured such that an update of the information data can be conducted from a database 17 according to the update circuit 15. The database 17 has, for example, fingerprint data of all the employees stored therein. When a new employee or worker is added or an employee or worker retires, his/her fingerprint information is always added to or erased from the database 17. Therefore, in the fingerprint information data 13, the latest fingerprint information data of the employees in the division can be held. The fingerprint collation input circuit 7 acquires the fingerprint of the worker from the fingerprint collation input device 3, and the acquired fingerprint is input into the search circuit 9. In the search circuit 9, the fingerprint information in the fingerprint information data 13 is searched, when data corresponding to the input fingerprint information is found, the data is output to the output circuit 11. A release signal is output from the output circuit 11.

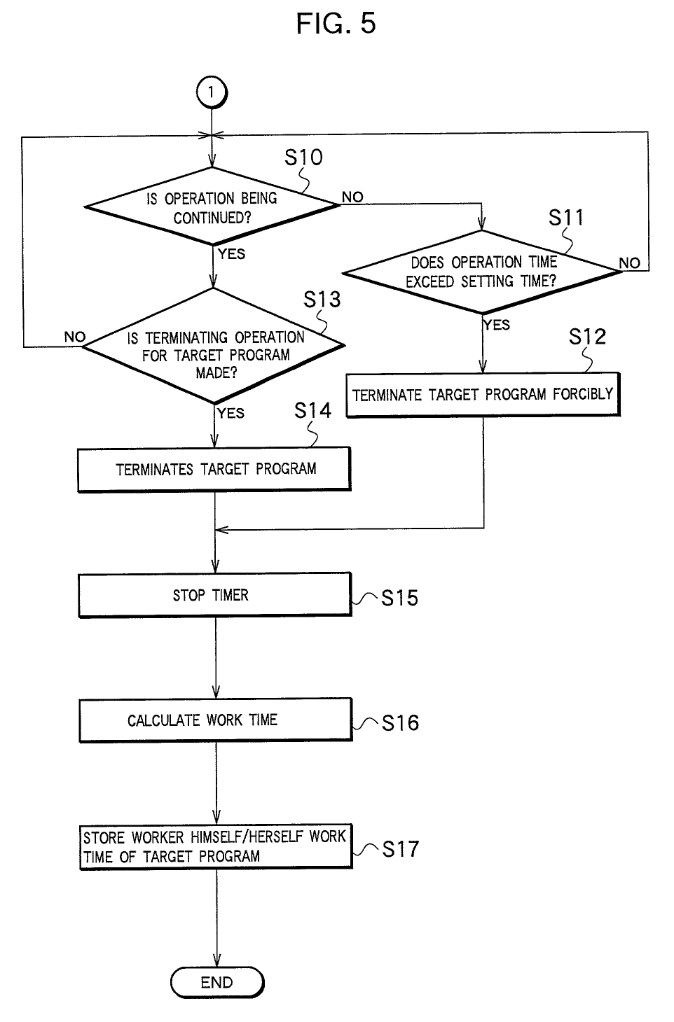

There will be explained an operation of a time management in the case where a target work program is worked according to the flowcharts of FIGS. 4 and 5.

At first, at step S1, a process restricting program activation is conducted so that a restricting program is activated. At step S2, a target program activation operation is conducted. In other words, the desktop PC 1 is operated by a worker so that a startup operation of the target work program is conducted. At step S3, a target program activation restricting is conducted. This step S3 configures the activation restricting means CL1 so that the activation restricting of the target work program is conducted.

Step S4 functions as the fingerprint inputting means CL2 so that a fingerprint input is conducted. This fingerprint input is conducted through the fingerprint input device 3 as described above, and moreover a configuration can be adopted in which a voice output of the desktop PC 1 such as “conduct fingerprint input” inform the worker about fingerprint input when the fingerprint input is conducted.

At step S5, a fingerprint information data reading is conducted and the information data is read from the fingerprint information data 13 to the search circuit 9. Step S6 functions as the fingerprint collating means CL4, where the read fingerprint information data and the input fingerprint information data are compared with each other and an authentication specifying a worker is conducted. At this step S6, when the worker specification authentication is not conducted, the activation restricting of the target work program is not released (S3).

At step S6, when the authentication specifying a worker is conducted, at step S7, the target work program activation restricting release is conducted. This step S7 functions as the restriction releasing means CL5 so that the release of the work program activation restricting is conducted. Next, at step S8, a timer activation is conducted. Step S8 functions as the work time recording means CL6 so that a count of the work time is started according to the timer activation.

At step S9, the target program activation is conducted, and the target work program is started on a screen of the desktop PC. Therefore, the worker can use a keyboard 19, a mouth 21 and the like of the desktop PC 1 to conduct work according to the target work program.

At step S10, a determination is made on whether the operation is being continued or not. This step S10 functions as work confirming means so that a determination is made on whether the operation of the target work program which is the work object is being continued or not. When the operation of the work program is stopped due to, for example, an absence of the worker, the control proceeds to step S11 so that a determination is made on whether a stopping time has exceeded a setting time. In the case where the stopping time has not exceeded the setting time, the control returns to the step S10, and in the case where the stopping time has exceeded the setting time, an automatic termination of the target work program is conducted at step S12.

The step S12 configures terminating means. When it is determined that the operation of the target work program which is the work object is not being operated, the work program is forcibly terminated, and the control proceeds to step S14.

At the step S10, when it is determined that the operation is continuously being operated, the control proceeds to step S13 so that a determination is made on whether the target work program termination operation has been conducted or not. When it is determined that the termination operation has not been conducted, the control returns to step S10. When it is determined that the termination operation has been conducted, at step S14, the target work program termination is conducted, thereby the work program is terminated. Next, the control proceeds to step S15 so that a timer stop is conducted and a count of the work time through the timer is terminated.

Step S16 functions as the work time recording means CL6 to conduct a work time calculation so that the work time is calculated on the basis of the count of the timer. At step S17, a worker himself/herself work time storage of the target work program is conducted so that, as the work time recording means CL6, the work time about a worker who worked and a work program which he/she used is stored in the memory.

Therefore, by outputting the contents stored in the memory, a management can be very easily made on information about a work program which each worker or employee operates, the contents of the work program and his/her work time. Further, in the above explanation, the explanation has been conducted according to one desktop PC 1, but, also in the case where many desktop PC 1 are provided, the work time can be similarly calculated and managed. In this case, it is possible to cause a mother computer to store all the stored worker himself/herself work time and to collectively manage the work time. Further, in the above embodiment, there is configured so that the fingerprint information data is fetched from the database 17, however, there can be configured so that the fingerprint of the worker is registered in advance through the fingerprint input device 3 for each desktop PC 1 and the registered fingerprint is to be the fingerprint information data 13. Further, a transfer of the data from the database 17 to the desktop PC 1 can be conducted via the Internet.

Thus, in the embodiment of the present invention, information about a work object which each worker or operator operates, the contents of the work object and his/her work time can easily be managed by management of the work time according to the fingerprint collation.

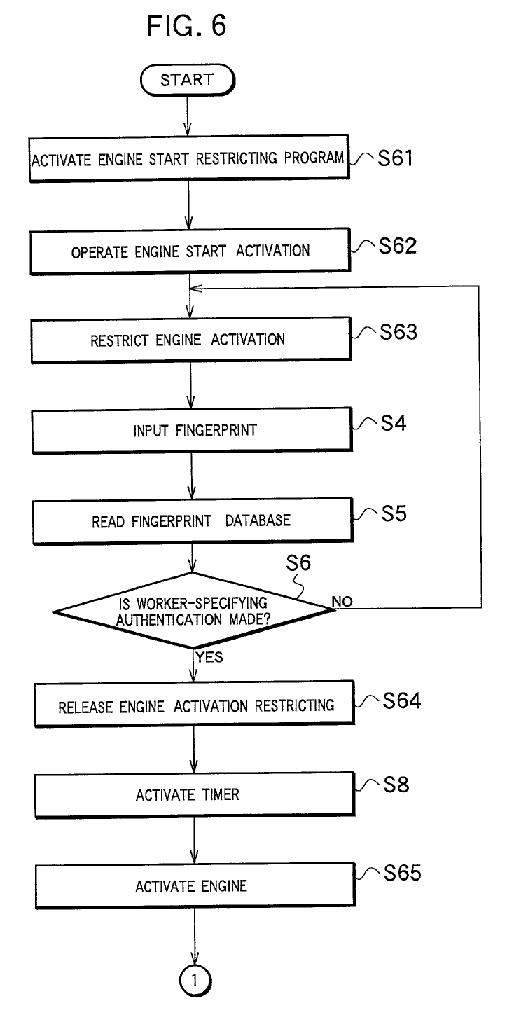

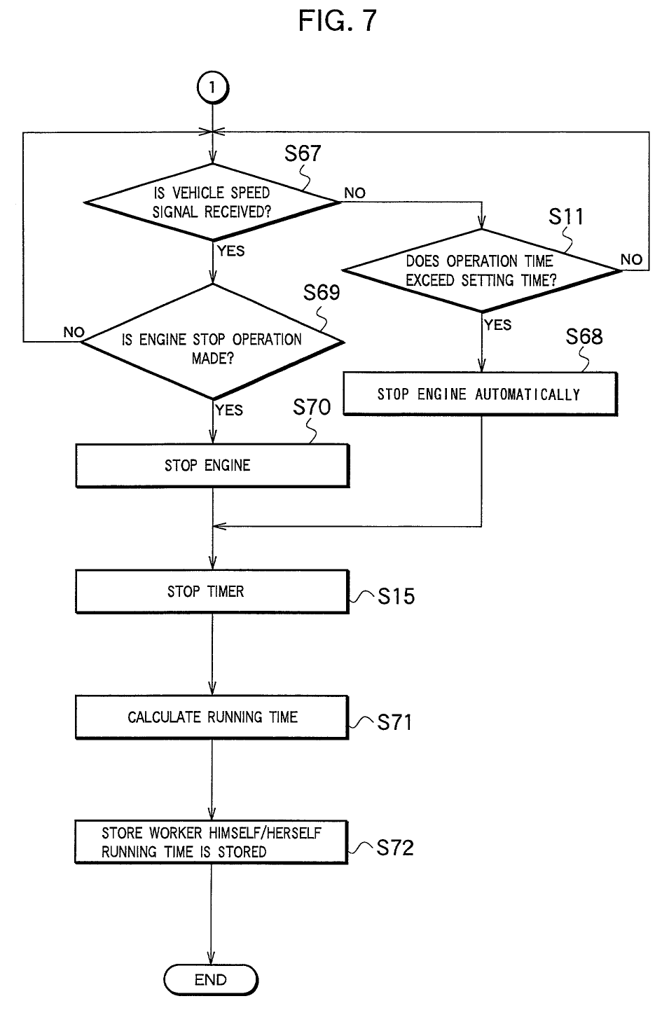

FIGS. 6 and 7 are flowcharts in the case that the work object is a vehicle. The flowcharts are basically identical to the flowcharts of FIGS. 4 and 5, and like numerals are denoted to the identical steps.

Meanwhile, in the present embodiment, at step S61, an engine start restricting program activation is started so that the engine start restricting program can be operated. Further, at step S62, an engine start activation operation is conducted. In other words, when the engine start operation is conducted through an ignition switch, an operation signal thereof is read. At step S63, an engine activation restricting is conducted, irrespective of the ignition operation, the engine activation restricting is conducted. The steps S4, S5, and S6 are conducted similarly as described above, at step S64, the engine activation restricting release is conducted, at step S8, the timer is activated, and at step S65, the engine is activated.

Next, the control proceeds to step S67 in FIG. 7, and a determination is made on whether a vehicle speed signal exists or not. When the vehicle is stopped and the vehicle speed signal does not exist, the control proceeds to step S11 so that a determination is made on whether the stopping time has exceeded the setting time. At this step S11, a determination is made on whether a constant time has been elapsed from a time when the vehicle is stopped. When the vehicle is stopped for the constant time or more, at step S68, the engine automatic stop is conducted so that the engine is stopped.

At the step S67, when the vehicle is running and it is determined that there is the vehicle speed signal, the control proceeds to step S69 so that a determination is made on whether the engine stop operation has been conducted or not. When it is determined that the engine stop operation has been conducted, at step S70, the engine stop is conducted so that the engine is stopped.

Next, at step S15, the timer counted is taken, at step S71, the running time calculation is conducted so that the running time which has been counted through the timer is calculated. At step S72, this running time is stored in the memory by conducting the worker himself/herself running time storage.

With such a management of the running time through the fingerprint collation, information about a vehicle which each driver drives, his/her running or driving time, and/or whether or not he/she takes a rest during his/her work time can be managed very easily.

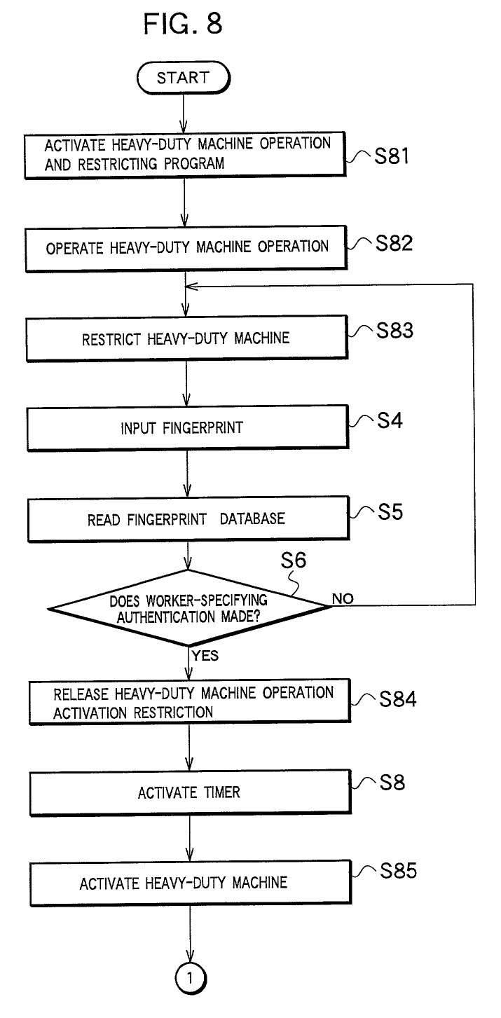

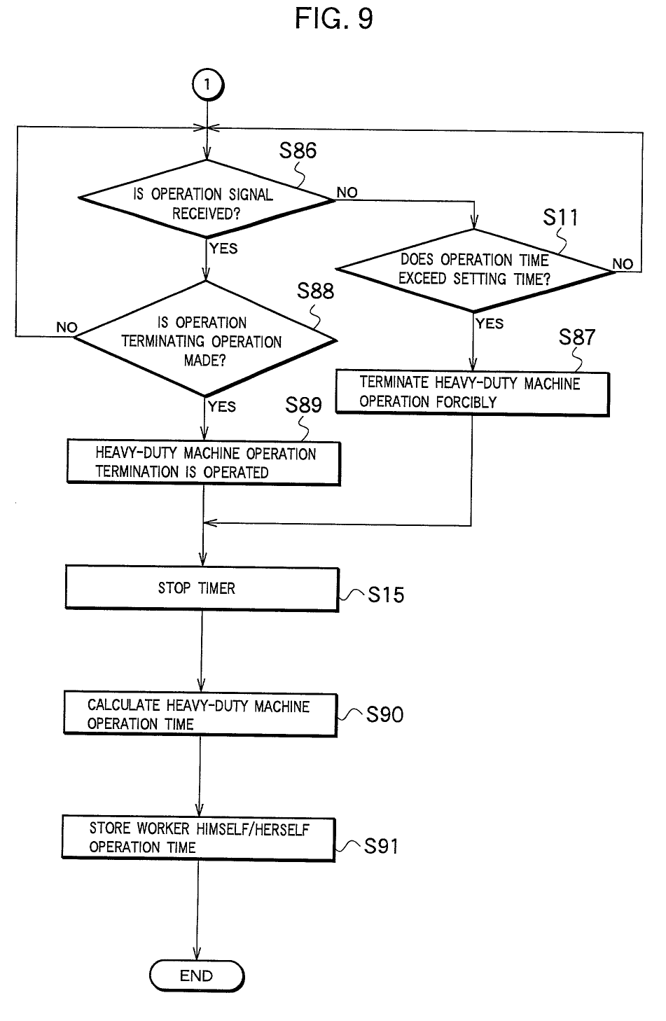

FIGS. 8 and 9 are flowcharts in the case where the work object is a heavy-duty machine. In addition, also in FIGS. 8 and 9, the identical steps to those in the above embodiment are denoted with like numerals.

At first, at step S81 in FIG. 8, the heavy-duty machine activation restricting program is started so that the heavy-duty machine activation restricting program can be operated. At step S82, a heavy-duty machine activation operation is conducted so that, when the heavy-duty machine is activated through a start button or the like, a signal thereof is read.

At step S83, the heavy-duty machine activation restricting is conducted so that, irrespective of the heavy-duty machine activation operation, the heavy-duty machine activation is restricted according to the heavy-duty machine restricting program. Steps S4, S5, and S6 are similarly conducted as described above. At step S84, the heavy-duty machine activation restricting release is conducted so that the heavy-duty machine activation restricting according to the heavy-duty machine restricting program is released.

At step S8, the timer activation is conducted so that the count of the work time is started. At step S85, the heavy-duty machine activation is conducted so that the heavy-duty machine is activated.

Next, at step S86 in FIG. 9, a determination is made on whether an operate signal of the heavy-duty machine exists or not. The operate signal includes an operation signal of an operation lever which the worker manually operates. When it is determined that the operate signal does not exist, the control proceeds to step S11. When it is determined that the stopping time has exceeded the setting time, which is determined as that the worker is absent from the heavy-duty machine, so that the control proceeds to step S87. At step S87, a heavy-duty machine operate forcible termination is conducted so that the heavy-duty machine is forcibly stopped, the control proceeds to step S15.

At step S86, when it is determined that the operate signal exists, at step S88, a determination is made on whether the operate termination operation has been conducted. At step S88, when it is determined that the operate termination operation has been conducted, the control proceeds to step S89 so that the heavy-duty machine operate termination operation is conducted so that the heavy-duty machine is stopped.

Next, the control proceeds to step S15, the count through the timer is stopped. At step S90, the heavy-duty machine operate time calculation is conducted so that the work time is calculated. Next, at step S91, the worker himself/herself operate time storage is conducted so that the work time in the specified heavy-duty machine of the specified worker is stored in the memory. Thereby, information about a worker who operates a heavy-duty machine, the kind of the heavy-duty machine and his/her operating time can be managed considerably easily.

In the present embodiment, there has been explained in the case where as the work object, a work program of an information device, a vehicle, or a heavy-duty machine is applied, however, the work object can be applied to an aircraft, a watercraft, a railroad vehicle, and other work objects.

What is claimed is:

1. A work time management method comprising the steps of:
when a worker activates a work object, restricting an activation of the work object;
when the worker inputs his/her fingerprint, collating the input fingerprint with a fingerprint of the worker which has been registered in advance, and releasing an activation restricting of the work object when a registered worker is specified through the fingerprint collation; and
counting a work time up to the time when the operation of the work object is terminated to record the work time of the specified worker on the basis of the fact that the activation restricting is released.

2. A work time management apparatus comprising:
activation restricting means for, when a worker activates a work object, restricting an activation of the work object;
fingerprint inputting means for inputting a fingerprint of the worker;
fingerprint registering means for registering a fingerprint of each worker in advance;
fingerprint collating means for collating the input fingerprint with the registered fingerprint of the worker;
restriction releasing means for, when a registered worker is specified through the fingerprint collation, releasing the restriction according to the activation restricting means; and
work time recording means for counting to record the work time up to the time when the operation of the work object is terminated on the basis of the fact that the restriction is released.

3. The work time management apparatus according to claim 2, further comprising:
work confirming means for making a determination on whether an operation of the work object is being conducted or not; and
terminating means for forcibly terminating the work object when it is determined that the operation of the work object is not being conducted,
wherein the work time recording means counts to record a work time up to the forcible termination.

4. The work time management apparatus according to claim 2 or 3, wherein the work object is any one of a work program of an information device, a vehicle, and a heavy-duty machine.
